(19) United States
(12) Patent Application Publication
(10) Pub. No.: US 2007/0232729 A1
(43) Pub. Date: Oct. 4, 2007

(54) Moisture Cross-Linking Composition Containing Alkoxysilyl Functional Particles

(75) Inventors: Christoph Briehn, Munchen (DE); Volker Stanjek, Munchen (DE); Richard Weidner, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: CONSORTIUM FUER ELEKTROCHEMISCHE INDUSTRIE GMBH, München (DE)

(21) Appl. No.: 11/568,637

(22) PCT Filed: Apr. 21, 2005
(86) PCT No.: PCT/EP05/04301

§ 371 Date: Nov. 3, 2006

(30) Foreign Application Priority Data
May 6, 2004 (DE) 102004022400.5

(51) Int. Cl. C08L 83/04

(52) U.S. Cl. 523/521; 524/588; 525/7.2

(57) ABSTRACT

Compositions which are crosslinkable contain an alkoxysilyl or hydroxyl-functional binder and functionalized particles prepared by reacting a filler having reactive groups on its surface with an alkoxysilane in which an alkoxysilyl group is linked to a heteroatom by an optionally substituted methylene spacer. The particle may react with the alkoxy group of the alkoxysilane or with a group containing the heteroatom of the alkoxysilane to functionalize the particles.

The invention relates to compositions which comprise alkoxysilyl-functional particles and can be cured by ingress of moisture, and to processes for preparing these compositions.

Moisture-crosslinkable compositions which cure to give masses possessing, for example, high mechanical hardness are known. They are described in publications including EP-A-571 073 and EP-A-1 123 951. The moisture-crosslinking prepolymers present in the compositions are prepared for example by reaction of isocyanates or isocyanate-functional prepolymers with amino-functional silanes, such as aminopropyltrimethoxysilane. Furthermore, they can also be prepared by reaction of polyols or OH-functional polyurethanes with isocyanate-functional alkoxysilanes, such as isocyanatopropyltrimethoxysilane.

It is common to add fillers (e.g., CaCO₃, carbon black, etc.) to these compositions in order to modify the profile of properties both of the uncured compositions (their viscosity, for example) and of the cured masses (their tensile strength, for example). In this context the fillers are generally not reactive toward the polymer matrix; that is, they are not bonded covalently to the polymer matrix in the course of curing.

Besides these, there are also free-radically curable compositions known, from documents including WO 00/22052 or WO 99/52964, which comprise nanoscale fillers and which cure to give masses of high mechanical hardness and chemical resistance. These are used in particular for producing scratchproof coatings. In these systems the high mechanical hardness of the cured compositions can be attributed to the chemical incorporation into the polymer matrix, in the course of curing, of correspondingly functionalized particles. For this purpose the particles are provided on their surface, by reaction with alkoxysilanes, with functional groups which are reactive toward the functionality of the polymer matrix. Thus, for example, U.S. Pat. No. 4,455,205 or U.S. Pat. No. 4,491,508 describe radiation-curable coating compositions which comprise an acryloyl-functional matrix polymer and also methacryloyl-functional SiO₂ particles.

One problem of the silyl-functional particles prepared in accordance with the prior art lies in their preparation. Thus the functionalization of particles which carry metal-OH (MeOH) and/or Si—OH groups is accomplished preferably with alkoxysilanes which carry no additional reactive organic function, such as with methyltrimethoxysilane, or else with silanes whose additional reactive organic function is separated by a propyl group from the alkoxysilyl function, such as aminopropyltrimethoxysilane. If desired, catalysts are also used in this context. Corresponding systems are described in, for example, EP 1 249 470 A and EP 1 245 627 A. Catalyst-free systems are often impossible to realize, owing to the relatively low reactivity of the customary alkoxysilanes.

Moreover, the low reactivity of the customary alkoxy-silanes also leads to further restrictions: For instance, it is possible to carry out condensation of OH-functional particles in an anhydrous medium with di- and/or trialkoxysilanes accompanied by release of alcohol, giving silanized particles attached to whose surface there are silyl groups which possess silicon-bonded alkoxy groups which have not yet been hydrolyzed. These groups can enter into condensation reactions in the presence of moisture, e.g., atmospheric humidity, with themselves, with other alkoxysilyl compounds, or else with alkoxysilyl-functional polymers. This occurs through hydrolysis of the alkoxysilyl groups and subsequent condensation, forming Si—O—Si bonds. In this way it is possible to effect curing of the corresponding material on contact with (atmospheric) moisture. The conventional silanes described above, however, possess such a low reactivity that this reaction can take place not at all or only extremely slowly and in the presence of catalysts. Systems with a high curing rate cannot be realized in this way. Moreover, the tin catalysts that are generally used to accelerate the cure are toxicologically objectionable. Particularly low reactivity toward moisture is exhibited by alkoxysilane-terminated systems when, rather than methoxysilyl groups, the even less reactive ethoxysilyl groups are employed. However, it is in many cases the last-mentioned ethoxy-crosslinking systems in particular that would be especially desirable, since in the course of curing they release only the toxicologically unobjectionable ethanol, rather than methanol.

It would therefore be desirable to have moisture-crosslinkable compositions comprising alkoxysilyl-functionalized particles with a significantly increased reactivity toward (atmospheric) moisture, which on ingress of atmospheric humidity cure to form materials in which the particles were embedded covalently in the matrix.

WO 03/18658 and WO 03/14226 effect silane termination of polydimethylsiloxanes and of organic polymers using functionalized alkoxysilanes distinguished by virtue of the fact that they contain alkoxysilyl groups which are separated by a methylene spacer from a heteroatom. These silanes, and the silane-crosslinking polymers prepared from these silanes, are distinguished, on contact with (atmospheric) moisture, by a drastically increased rate of hydrolysis and condensation. The acceleration of reaction is so great in that case that the proportion of catalysts required can be reduced significantly or it is even possible to do without added catalyst altogether. Nevertheless, the use of these highly reactive silanes has to date been described only for the functionalization of (pre)polymers. Highly reactive prepolymers of this kind can be prepared, for example, by reaction of OH-functional polymers with alkoxysilanes, by copolymerization of methacrylatomethylsilanes with ethylenically unsaturated monomers, as described in publications including DE 101 40 131 A, or by reaction of isocyanate-functional polymers with aminosilanes, as described in WO 03/018658, for example, and they are suitable, among other things, as binders for coatings and also as sealants and adhesives.

It is an object of the present invention to provide moisture-crosslinking compositions comprising alkoxysilyl-functional particles that do not have the abovementioned disadvantages of the known systems and which are notable in particular for a significantly increased curing rate.

The invention provides moisture-crosslinking compositions Z comprising

binder B selected from alkoxysilyl-functional binders BS and OH-functional binders BO

and also moisture-crosslinkable particles PS which are preparable by reacting

particles P of a material selected from metal oxides, metal-silicon mixed oxides, silicon dioxide, in particular pyrogenic and colloidal silicon dioxide and organopolysiloxane resins and combinations thereof, and possessing functions selected from Me-OH, Si—OH, Me-O-Me, Me-O—Si—, Si—O—Si, Me-OR², Si—OR², and groups H which are reactive toward the group A and via which a reaction with the organosilanes S can take place with organosilanes S of the general formula I,
(R²O)₃₋ᵥR¹ᵥSi—CR³₂-A (I)
where
Me is a metal atom,
A is a group selected from —OR⁴, —P(O)(OR⁴)₂, —N(R⁴)₂, —NH—CO—N (R⁴), —N(R⁴)—CO—NH (R⁴), —O—CO—N (R⁴)₂, —NH—CO—OR⁴, 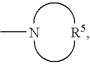
R¹ is an alkyl, cycloalkyl, aryl or arylalkyl radical having in each case 1 to 12 C atoms, it being possible for the carbon chain to be interrupted by nonadjacent oxygen, sulfur or NR³ groups,
R² is hydrogen or an alkyl, cycloalkyl or aryl radical having in each case 1 to 6 C atoms, it being possible for the carbon chain to be interrupted by nonadjacent oxygen, sulfur or NR³ groups,
R³ is hydrogen or an alkyl, cycloalkyl, arylalkyl, aryl, aminoalkyl or aspartic ester radical,
R⁴ is hydrogen or an alkyl, cycloalkyl, arylalkyl, aryl, aminoalkyl, aspartic ester, —CO—CH═CH₂ or —CO—C(CH₃)═CH₂ radical,
R⁵ is a difunctional, unsubstituted or substituted alkyl or arylalkyl radical which in the alkyl chain optionally possesses oxygen atoms, carbonyl groups, NH— functions or an NR⁴ function, and
v is 0, 1 or 2.

Besides suitably functionalized binders, the compositions Z comprise alkoxysilyl-functional particles PS whose particle-bonded alkoxysilyl groups are separated by a methylene group from a heteroatom. As a result of this the particles exhibit high reactivity toward moisture. In this way, in comparison to the known systems, the compositions z acquire a significantly increased curing rate. On ingress of moisture, even in the absence of catalysts, there is rapid hydrolysis and subsequent condensation of the alkoxysilyl functions, forming Si—O—Si bonds.

On ingress of moisture the compositions Z cure by polycondensation to form materials in which the particles PS are bonded covalently via Si—O—Si bonds to the binder B. The covalent incorporation of the particles into the matrix results in a distinct improvement in the properties of the cured materials.

The organosilicon component of the particles PS that is introduced by the organosilanes S can be bonded via the Si or via the group A to the particles. This organosilicon constituent of the particles PS is reactive toward the binder BO and/or BS and moisture.

For R¹ methyl and phenyl, for R² methyl and ethyl, and for R³ hydrogen are particularly preferred. With preference v adopts the value 0.

In the moisture-crosslinking compositions Z the organosilicon constituents immobilized on the particles PS carry, optionally, one, two or three alkoxy groups, preferably two or three alkoxy groups (v=0 or 1).

As alkoxy-functional binders BS it is preferred to use compounds whose alkoxysilyl functions are separated by a methylene group from a heteroatom. The alkoxysilyl-functional binder BS can in this case be in the form of monomeric, oligomeric or polymeric compounds. Examples of suitable monomeric binders are silicic esters, such as tetraethoxysilane. Examples of suitable oligomeric and polymeric binders are alkoxysilyl-functional compounds whose backbone is composed of an epoxy resin, a polyurethane, a poly(meth)acrylate, a polyether or polyester.

As OH-functional binders BO it is preferred to use compounds which are reactive toward the alkoxysilyl-functional particles PS. Where binders BO of this kind are used, they are preferably employed in a substoichiometric amount relative to the alkoxysilyl functions of the particle PS, so that in the composition Z they continue to remain alkoxysilyl functions which allow moisture crosslinking of the composition Z. Preferred examples of such binders are, in particular, Si—OH— functional siloxanes.

For the compositions Z it is possible to use one or more different binders BO, binders BS or mixtures thereof.

The amount of particles PS present in the composition Z, based on the overall weight, is preferably at least 5% by weight, more preferably at least 10% by weight, and in particular at least 15% by weight.

The particles PS can be prepared in the presence or absence of the binder B.

The compositions Z are prepared preferably in a two-stage process. In the first stage the particles P are functionalized with alkoxysilanes S. In the second step the functionalized particles PS are incorporated into the binder B.

In an alternative process the composition Z is prepared by functionalizing the particles P with the alkoxysilanes S in the presence of the binder B. When the particles PS are prepared in the presence of the binder BO, not only the particle P but also the OH-functional binder BO can be functionalized with the silane S. In this way, starting from a mixture comprising binder BO and particle P, it is possible to obtain the composition Z comprising binder BO and particle PS. This process will be referred to below as the in situ process.

For the preparation of the moisture-crosslinking particles PS it is possible as particles P to use full metal oxide particles and metal mixed oxide particles (e.g., aluminum oxides such as corundum, aluminum mixed oxides with other metals and/or silicon, titanium oxides, zirconium oxides, iron oxides, etc.), silicon oxide particles (e.g., colloidal silica, pyrogenic silica, precipitated silica) or silicon oxide compounds in which some of the valences of the silicon have been provided with organic radicals (e.g., organopolysiloxane resins). The particles P are notable, moreover, for the fact they possess metal hydroxide (MeOH) and/or silicon hydroxide (SiOH) functions and/or metal alkoxide (MeOR²) and/or silicon alkoxide (SiOR²) and/or SiOSi and/or MeOMe and/or MeOSi units and/or group A-reactive groups H via which a reaction with the organosilanes S can take place.

The functions H are organic functions which are reactive toward the organic function A of the alkoxysilanes S of the general formula I. The organic functions H are preferably selected from carboxyl, carbonyl, ester, thiol, amino, carbinol, epoxy, acrylic, and methacrylic groups, more preferably amino, carbinol, epoxy, acrylic, and methacrylic groups.

The particles P and PS possess preferably an average diameter of less than 1000 nm, more preferably less than 100 nm, the particle size being determined by transmission electron microscopy.

In one preferred version of the invention the particles P are composed of pyrogenic silica. In a further preferred version of the invention the particles P used are colloidal silicon oxides or metal oxides, present preferably in the form of a dispersion of the corresponding oxide particles of submicron size in an aqueous or organic solvent. In this case it is possible with preference to use the oxides of the metals aluminum, titanium, zirconium, tantalum, tungsten, hafnium, and tin.

Likewise employed with preference, moreover, are particles P of silicone resins of the general formula II,
(R⁶₃SiO_{1/2})ₖ(R⁶₂SiO_{2/2})ₗ(R⁶SiO_{3/2})ₘ(SiO_{4/2})ₙ(O_{1/2}R⁷)ₜ (II)
where
R⁶ is hydrogen or an unsubstituted or halogen-substituted, epoxy- acryloyl-, methacryloyl-, carboxy-, carbonyl-, ester-, amine-, thiol-, carbinol-functional aromatic or aliphatic hydrocarbon radical having 1-18 carbon atoms and
R⁷ has the definitions of R²,
k has a value greater than or equal to 0,
l has a value greater than or equal to 0,
m has a value greater than or equal to 0,
n has a value greater than or equal to 0,
t has a value greater than or equal to 0,
   and the sum of k+l+m+n has a value of at least 1, preferably at least 5.

For the compositions Z it is possible to use one or more different types of particles P and/or PS. Thus, for example, it is possible to prepare systems which as well as nanoscale SiO₂ also contain corundum.

Preferred silanes S of the general formula I are α-aminomethylsilanes such as aminomethyl-triethoxy-silane, aminomethyl-methyldiethoxysilane, N-cyclohexyl-aminomethyl-triethoxysilane, N-cyclohexylaminomethyl-methyldiethoxysilane, N-ethylaminomethyl-triethoxy-silane, N-ethylaminomethyl-methyldiethoxysilane, N-butylaminomethyl-triethoxysilane, N-butylaminomethyl-methyldiethoxysilane, N-phenylaminomethyl-triethoxy-silane, N-phenylaminomethyl-methyldiethoxysilane, O-methylcarbamatomethyl-triethoxysilane, O-methyl-carbamatomethyl-methyldiethoxysilane, N,N-diethylamino-methyl-triethoxysilane, N,N-diethylaminomethyl-methyl-diethoxysilane, N,N-dibutylaminomethyl-triethoxysilane, N,N-dibutylaminomethyl-methyldiethoxysilane, N-(tri-ethoxysilylmethyl)piperazine, N-(methyldiethoxysilyl-methyl)piperazine, N-(triethoxysilylmethyl)morpholine, N-(methyldiethoxysilylmethyl)morpholine etc. Particular preference is given additionally to α-oxymethylsilanes such as methacryloyloxymethyl-triethoxysilane, methacryloyloxymethyl-methyldiethoxysilane, methoxy-methyl-triethoxysilane, methoxymethyl-methyldiethoxy-silane, glycidyloxymethyl-triethoxysilanes, and glycidyloxymethyl-methyldiethoxysilane. Particular preference is given additionally to α-phosphonato-methylsilanes such as diethylphosphonic ester-methyl-triethoxysilane, diethylphosphonic ester-methyl-methyldiethoxysilane. As well as the silanes S listed here with ethoxysilyl groups, the corresponding methoxysilanes are likewise preferred.

For the functionalization of particles P it is possible to use one alkoxysilane S individually or a mixture of different silanes S of the general formula I or else a mixture of silanes S of the general formula I with other alkoxysilanes. It is possible, furthermore, to use hydrolysis products or condensation products of the alkoxysilanes S and/or the mixtures comprising the alkoxysilanes S. For the silanization it is possible for particles P to be present alternatively as a dispersion or sol in a preferably nonaqueous solvent or in the form of a powder.

In accordance with the above-described two-stage or in situ process, the particles PS can be prepared in different ways:

The particles PS present in the compositions Z are prepared preferably by a process in which MeOH— and/or SiOH-functional particles P are reacted with alkoxy-silanes S of the general formula I. In this case the alkoxysilanes S are bonded to the particles by an Si—O—Si and/or Me-O—Si bond. Owing to the high reactivity of the silanes S of the general formula I whose alkoxysilyl group is separated by a methyl group from a heteroatom, these compounds are highly suitable for the surface functionalization of particles. The functionalization of the particles P with these reactive silanes takes place rapidly and completely.

In an alternative process for preparing the compositions Z the particles P, especially organopolysiloxane resins possessing on their surface functions selected from MeOH, SiOH, MeOR², SiOR², SiOSi, MeOMe, and SiOMe, are functionalized by equilibration or cohydrolysis with the silanes S. Both the cohydrolysis and the equilibration can be carried out in the presence of catalysts. The underlying processes of cohydrolysis and equilibration for the preparation of functionalized particles, particularly organopolysiloxane resins, have been widely described in the literature. With preference the particles P are reacted with silanes S of the general formula I where v=0 or 1 and more preferably where v=0.

A further possibility is to prepare the particles PS present in the compositions Z by reacting particles P possessing organic functions H on their surface with organosilanes S of the general formula I. In this case the alkoxysilanes S are bonded to the organic function H of the particle via the organic function A. In this process it is preferred to use organosilanes S of the general formula I where v=0.

In all of the preparation processes the particles PS can be present alternatively as a dispersion, preferably in a nonaqueous solvent, in the solid state, or, in the case of organopolysiloxane resins, as a liquid.

The compositions Z may, furthermore, comprise common solvents and also the additives and adjuvants that are typical in formulations. Examples of these would include flow control assistants, surface-active substances, adhesion promoters, light stabilizers such as UV absorbers and/or free-radical scavengers, thixotropic agents, and also further solids and fillers. To produce the particular profiles of properties that are desired, both for the compositions Z and also for the cured masses, adjuvants of this kind are particularly preferred. This is true especially when the compositions Z are to be used as coatings. The compositions Z may also comprise dyes and/or pigments.

The compositions Z are cured by ingress of atmospheric humidity. Curing takes place preferably at 0-100° C., more preferably at 10-40° C.

The masses obtained after the compositions Z have cured display better properties than the corresponding compositions without particles. Thus, for example, when the cured compositions Z are used as elastomers, the tear strength can be increased. When the cured compositions Z are used as a coating, the mechanical hardness can be improved.

All symbols in the above formulae have their definitions in each case independently of one another.

The organopolysiloxane resins used in the examples for the particles P can be prepared in accordance with the processes described in U.S. Pat. No. 5,548,053 A, EP 640 109 A, and DE 19857348 A. The OH-free MQ resin employed, 803, is available under the name MQ-Harz Pulver 803 from Wacker-Chemie GmbH, Munich, Germany.

In the examples below, unless indicated otherwise, all amounts and percentages are by weight, all pressures are 0.10 MPa (abs.), and all temperatures are 20° C.

### EXAMPLE 1

General operating instructions: a solution of 5.00 g of an organopolysiloxane resin (see below) in 10 ml of dry toluene is added dropwise to a solution of an N-substituted aminomethylsilane (1.2 equivalents based on the OH content of the organopolysiloxane resin; see below and cf. Table 1) in 5 ml of dry toluene and the mixture is stirred at room temperature for 6 hours. In accordance with the general operating instructions, 5.00 g portions of an MQ resin (resin of composition (Me₃SiO_{1/2})_{0.4} (SiO_{4/2})_{0.6}(O1/2R⁴)_{0.2}, with R⁴ independently at each occurrence being hydrogen or ethyl radical, with an average molecular weight Mw of 1400 g/mol and an OH group content of 3.4% by weight), phenyl resin (resin of composition (Me₂SiO_{2/2})0.4(SiO_{4/2})0.6 (O_{1/2}R⁴)_{0.2}, with R⁴ independently at each occurrence being hydrogen or ethyl radical, an average molecular weight Mw of 1600 g/mol, and an OH group content of 4.8% by weight) or methyl resin (resin of composition (MeSiO_{3/2})_{1.0}(O_{1/2}R⁴)_{0.3}, with R⁴ independently at each occurrence being hydrogen or ethyl radical, an average molecular weight Mw of 1600 g/mol and an OH group content of 2.9% by weight) are reacted with 2.79 g, 3.91 g or 2.24 g, respectively, of cyclohexylaminomethyl-trimethoxysilane (1.2 equivalents in each case, based on the respective OH content of the resins). Added to each of the toluenic solutions were 12.85 g, 17.90 g or 10.28 g, respectively (10 mol % in each case, based on the respective SiOH content of the resins) of an OH-terminal polydimethylsiloxane (MW about 12 600, viscosity 582 mm²/s) and the mixtures were stirred at room temperature for 30 minutes. After the solvent had been removed by distillation, the mixtures were applied to a PET film in a coat thickness such that 24-hour curing with ingress of atmospheric humidity at room temperature resulted in a film approximately 5 mm thick. For the purpose of removing residual solvent, the crosslinked films were aftertreated at 100° C. for 72 h.

### Comparative Example 1

In the same way as in Example 1, a noninventive composition was prepared and was cured to a film, by reacting 5.00 g of the MQ resin MQ 803, which does not carry any SiOH groups, instead of the MQ resin used in Example 1, with 2.79 g of cyclohexylaminomethyl-trimethoxysilane.

### Comparative Example 2

In the same way as in Example 1, a noninventive composition was prepared and was cured to a film, by reacting 5.00 g of the MQ resin used in Example 1 with 2.15 g of γ-aminopropyl-trimethoxysilane.

### EXAMPLE 2

The degree of crosslinking was characterized, and the extractable fraction of the films produced in Example 1 and in Comparative Examples 1 and 2 determined, by swelling these films in toluene at 25° C. for 12 days. The extractable fraction was determined gravimetrically. As a measure of the degree of crosslinking, the reciprocal equilibrium swelling index 1/Q was determined in accordance with DIN 53521, and is defined as follows:
1/Q=a/(b−a)
where a: weight of swollen sample body after complete drying
b: weight of swollen sample body

The data measured are summarized in Table 1. The results of measurement of the reaction products of MQ resin 803 (entry: Comparative Example C1), which carries no SiOH functions, and also of the MQ resin (entry: Example 1a), which has an OH content of 3.4% by weight, are directly comparable with one another and show the covalent incorporation of the surface-modified MQ resin.

TABLE 1

| | | | | | Reciprocal |
|---|---|---|---|---|---|
| | | | | | equilibrium |
| | | | | Extractable | swelling |
| | | | Film | fraction (% | index |
| Ex. | Resin | Silane | property | by weight) | 1/Q |
| 1a^{(a)} | MQ | Cy-TMO^{(c)} | Transparent, | 1.7 | 0.707 |
| | | | elastomeric, | | |
| | | | slightly | | |
| | | | brittle | | |
| 1b^{(a)} | Phenyl | Cy-TMO^{(c)} | Cloudy | 8.2 | 0.314 |
| | | | beige, | | |
| | | | elastomeric | | |
| 1c^{(a)} | Methyl | Cy-TMO^{(c)} | Transparent, | 5.7 | 0.941 |
| | | | very brittle | | |
| C1^{(b)} | MQ 803 | Cy-TMO^{(c)} | Transparent, | 20.2 | 0.280 |
| | | | very brittle | | |
| C2^{(b)} | MQ | γAP-TMO^{(d)} | Transparent, | 18.7 | 0.431 |
| | | | very brittle | | |

^{(a)}Example according to the invention.
^{(b)}Example not according to the invention.
^{(c)}Cy-TMO = cyclohexylaminomethyl-trimethoxysilane.
^{(d)}γAP-TMO = γ-aminopropyl-trimethoxysilane.

### EXAMPLE 3

In the same way as in Example 1, 5.00 g of the MQ resin used in Example 1, which has an OH content of 3.4% by weight, were reacted with 2.65 g of morpholinomethyl-trimethoxysilane (1.2 equivalents, based on the OH content of the resin). The toluene solution obtained was then combined, in the same way as in Example 1, with 12.85 g (10 mol %, based on the OH content of the resin) of an OH-terminal polydimethylsiloxane (Mw about 12 600, viscosity 582 mm²/s) and the mixture was stirred at room temperature for 30 minutes. The mixture obtained after the solvent had been distilled off was spread using a doctor blade into a polytetrafluoro-ethylene mold 3 mm high. For curing, the mass was stored with ingress of atmospheric humidity at room temperature for 24 hours, at 100° C. for 72 hours, and at room temperature for 14 days.

### Comparative Example 3

In the same way as in Example 3, a noninventive composition was prepared and cured, by reacting, instead of the MQ resin used in Example 3, 5.00 g of MQ resin 803, which carries no SiOH functions, with 2.65 g of morpholinomethyl-trimethoxysilane.

### Comparative Example 4

In the same way as in Example 3, a noninventive composition was prepared and cured, by reacting 5.00 g of the MQ resin used in Example 3, which has an OH content of 3.4% by weight, with 2.15 g of γ-aminopropyl-trimethoxysilane.

### EXAMPLE 4

To determine the mechanical properties of the masses described in Example 3 and in Comparative Examples 3 and 4, S1 test specimens were punched from them and their tensile properties were subjected to measurement in accordance with EN ISO 527-2 on a Zwick Z010. The properties determined in the course of these measurements are listed in Table 2.

The results of measurement for the reaction products of the MQ resin 803 (entry Comparative Example C3, not inventive), which carries no SiOH functions, and of the MQ resin used in Example 1 (entry Example 3), which has an OH content of 3.4% by weight, are directly comparable with one another and show the covalent incorporation of the surface-modified MQ resin.

TABLE 2

| | | | Breaking stress | Breaking |
|---|---|---|---|---|
| Ex. | Resin | Silane | (MPa) | extension (%) |
| 3^{(a)} | MQ | Morph-TMO^{(c)} | 2.08 | 252 |
| C3^{(b)} | MQ 803 | Morph-TMO^{(c)} | 0.36 | 149 |
| C4^{(b)} | MQ | γAP-TMO^{(d)} | Not | Not |
| | | | determinable^{(e)} | determinable^{(e)} |

^{(a)}Example according to the invention.
^{(b)}Example not according to the invention.
^{(c)}Morph-TMO = morpholinomethyl-trimethoxysilane.
^{(d)}γAP-TMO = γ-aminopropyl-trimethoxysilane.
^{(e)}Test specimen fragile, brittle.

### EXAMPLE 5

A 250 ml reaction vessel with stirring, cooling, and heating means was charged with a mixture of 10.00 g (59.45 mmol) of hexamethylene diisocyanate (HDI) and 63.25 g (356.88 mmol) of isocyanatomethyl-trimethoxy-silane and this initial charge was heated to 60° C. Subsequently there are 0.03 g of dibutytin dilaurate and 41.22 g (158.54 mmol) of a polypropylene-glycerol with an average molar mass of 260 g/mol. The temperature in this case ought not to rise to above 80° C. After the end of the addition the mixture is stirred at 60° C. temperature for a further 60 minutes. In the course of this procedure, only the isocyanate function of the isocyanatomethyl-trimethoxysilane reacted with the OH groups of the polyol. The reaction of the OH functions of the polyol with the trimethoxy-silyl groups of the isocyanatomethyl-trimethoxysilane, a reaction which in principle could also be imagined, was not found, within the bounds of measurement accuracy (NMR, HPLC-MS).

In the resultant prepolymer mixture it was not possible by IR spectroscopy to detect any remaining isocyanate groups. The product obtained was a clear, transparent mixture which had a viscosity of approximately 3 Pas at 20° C. Without addition of a further catalyst, this mixture had a skin-forming time in air of several hours, and so could be handled and processed further without problems.

### EXAMPLE 6

38.50 g of an SiO₂ organosol (IPA-ST® from Nissan Chemicals, 30% by weight SiO₂, 12 nm) are admixed dropwise over the course of 1 minute with 7.00 g of methyl trimethoxysilylmethylcarbamate and the mixture is stirred at room temperature for 3 d. Added dropwise to the transparent dispersion are 3.46 g of a silane-crosslinking prepolymer from Example 1, and the mixture is stirred at room temperature for 3 h. The result is a transparent dispersion having an SiO₂ content of 53% by weight (based on the solids content of 45% by weight).

### EXAMPLE 7

4.4 g of the particle-containing mixture from Example 6 and 4.0 g of the silane-crosslinking prepolymer from Example 5 are mixed homogeneously and that mixture is admixed with 0.01 g of bis(2-dimethylaminoethyl) ether (Jeffcat ZF20® from Huntsman). The result is a coating formulation which—based on the solids content—is composed to an extent of approximately 17.5% by weight of SiO₂.

### EXAMPLE 8

The coating formulation from Example 7 was applied by knife coating, using a Coatmaster® 509 MC film-drawing apparatus from Erichsen, with a coating bar with a slot height of 120 μm, to a glass plate. Subsequently it was cured at room temperature (20° C., 30% atmospheric humidity). The tack-free time was approximately 15 minutes, and after 24 hours the coating material already possessed a very high hardness, albeit not yet curing, the coating was stored at room temperature for 2 weeks.

The reference used was a particle-free coating formulation composed of 6 g of prepolymer from Example 5, 1.5 g of isopropanol, and 0.01 g of bis(2-dimethylaminoethyl) ether (Jeffcat ZF20® from Huntsman). This formulation was knife-coated by the same method to a glass plate and cured like the coating of the invention. In this case the reference exhibited a largely identical cure behavior.

Both with the coating sample of the invention and with the reference, visually attractive and smooth coatings were obtained. The gloss of these coatings—as determined with a Micro gloss 200 glossmeter from Byk—was approximately 180 gloss units for both coating materials.

### EXAMPLE 9

The scratch resistance of the coating films produced in accordance with Example 8 is determined using a Peter-Dahn abrasion-testing instrument. For this purpose a Scotch Brite® 2297 abrasive nonwoven with an area of 45×45 mm is loaded with a weight of 1 kg and scratched using 50 strokes. Both before the beginning and after the end of the scratch tests, the gloss of the respective coating is measured using a Micro gloss 20° glossmeter from Byk. As a measure of the scratch resistance of the respective coating, the loss of gloss is ascertained (average value from 3 coating samples in each case):

TABLE 3
Loss of gloss in the Peter-Dahn scratch test

| Coating sample | Loss of gloss |
|---|---|
| Example 7 (inventive) | 11 ± 2% |
| Reference (not inventive) | 44 ± 3% |

1-11. (canceled)

12. A moisture-crosslinking composition comprising at least one alkoxysilyl-functional binder, OH-functional binder, or mixture thereof, and moisture-crosslinkable particles prepared by reacting:
particles of a material comprising metal oxides, metal-silicon mixed oxides, silicon dioxide, colloidal silicon dioxide, organopolysiloxane resins or combinations thereof, possessing at least one functionality M-OH, Si—OH, M-O-M, M-O—Si—, Si—O—Si, M-OR², Si—OR², or a group H which is reactive toward a group A,
with organosilane(s) of the formula I,
(R²O)₃₋ᵥR¹ᵥSi—CR³₂-A (I)
where
M is a metal atom,
A is —OR⁴, —P(O)(OR⁴)₂, —N(R⁴)₂, —NH—CO—N(R⁴), —N(R⁴)—CO—NH(R⁴),—N(R⁴)₂, —NH—CO—OR⁴, or 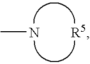
R¹ is an alkyl, cycloalkyl, aryl or arylalkyl radical, 1 to 12 C atoms, the carbon chain of the alkyl, cycloalkyl, aryl, or arylalkyl radical optionally interrupted by one or more nonadjacent oxygen, sulfur or NR³ groups,
R² is hydrogen or an alkyl, cycloalkyl or aryl radical having 1 to 6 C atoms, the carbon chain of the alkyl, cycloalkyl, or aryl radical optionally interrupted by nonadjacent oxygen, sulfur or NR³ groups,
R³ is hydrogen or an alkyl, cycloalkyl, arylalkyl, aryl, aminoalkyl or aspartic ester radical,
R⁴ is hydrogen or an alkyl, cycloalkyl, arylalkyl, aryl, aminoalkyl, aspartic ester, —CO—CH═CH₂ or —CO—C(CH₃)═CH₂ radical,
R⁵ is a difunctional, unsubstituted or substituted alkyl or arylalkyl radical which in the alkyl chain optionally possesses oxygen atoms, carbonyl groups, NH— functions or an NR⁴ function, and
v is 0, 1 or 2.

13. The composition of claim 12, wherein R² is methyl or ethyl.

14. The composition of claim 12, wherein at least one group H is selected from the group consisting of carboxyl, carbonyl, ester, thiol, amino, carbinol, epoxy, acrylic and methacrylic groups.

15. The composition of claim 13, wherein at least one group H is selected from the group consisting of carboxyl, carbonyl, ester, thiol, amino, carbinol, epoxy, acrylic and methacrylic groups.

16. The composition of claim 12, wherein the particles possess an average diameter of less than 1000 nm as determined by transmission electron microscopy.

17. The composition of claim 12, wherein the particles comprise of pyrogenic or colloidal silica.

18. The composition of claim 12, wherein the amount of the particles contained in the composition is at least 5% by weight, based on the total weight of the composition.

19. The composition of claim 12, wherein the composition contains alkoxy-functional binders, at least a portion of the alkoxy-functional binders comprising compounds whose alkoxysilyl functions are separated by a methylene group from a heteroatom.

20. The composition of claim 13, wherein the composition contains alkoxy-functional binders, at least a portion of the alkoxy-functional binders comprising compounds whose alkoxysilyl functions are separated by a methylene group from a heteroatom.

21. The composition of claim 14, wherein the composition contains alkoxy-functional binders, at least a portion of the alkoxy-functional binders comprising compounds whose alkoxysilyl functions are separated by a methylene group from a heteroatom.

22. The composition of claim 12, wherein the alkoxysilyl-functional binder comprises monomeric, oligomeric, or polymeric compounds.

23. The composition of claim 12, wherein OH-functional binders are present, and comprises Si—OH-functional siloxanes.

24. A process for preparing a composition of claim 12, comprising, functionalizing the particles with alkoxysilanes (I) to give functionalized particles, in the presence or absence of binder, and if binder is not present during functionalizing, subsequently admixing the functionalized particles with the binder.

25. The process of claim 24, wherein the particles are functionalized with the alkoxysilanes in the presence of the binder.

26. The process of claim 24 which is a two step preparation, functionalizing taking place in the first step, and admixing with binder taking place in a second step.
